(19) United States
(12) Patent Application Publication
(10) Pub. No.: US 2012/0060793 A1
(43) Pub. Date: Mar. 15, 2012

(54) System and Method for Controlling Fuel Injection

(75) Inventor: Youngho KIM, Suwon-si (KR)

(73) Assignee: Hyundai Motor Company, Seoul (KR)

(21) Appl. No.: 12/957,143

(22) Filed: Nov. 30, 2010

(30) Foreign Application Priority Data
Sep. 14, 2010 (KR) 10-2010-0090133

(51) Int. Cl. F02B 3/00; F02M 69/46

(52) U.S. Cl. 123/299; 123/456

(57) ABSTRACT

A system for controlling fuel injection which injects a fuel to an engine through main injection and/or pilot injection may include a detecting portion detecting a driving condition of the engine, a control portion calculating a change amount of the driving condition from the driving condition of the engine, and deciding actual fuel injection factors based on the driving condition of the engine and the change amount of the driving condition, a high pressure pump controlling a rail pressure according to the actual fuel injection factors, and an injector injecting the fuel according to the actual fuel injection factors.

### CROSS-REFERENCE TO RELATED APPLICATION

The present application claims priority to Korean Patent Application No. 10-2010-0090133 filed in the Korean Intellectual Property Office on Sep. 14, 2010, the entire contents of which is incorporated herein for all purposes by this reference.

### BACKGROUND OF THE INVENTION

1. Field of the Invention

The present invention relates to a system and a method for controlling fuel injection, and particularly to a system and a method for controlling fuel injection which reduces combustion noise and improves fuel economy by deciding actual fuel injection factors according to a change amount of a driving condition and injecting a fuel according to the actual fuel injection factors when acceleration.

2. Description of Related Art

It is generally known that a diesel vehicle, compared with a gasoline vehicle, generates more soot and smoke and larger vibration/noise. A diesel particulate filter (DPF) is mounted at the diesel vehicle so as to reduce such soot and smoke, and multi-pilot injection is introduced in the diesel vehicle so as to reduce vibration/noise. In addition, various means for improving combustion is being introduced in the diesel vehicle.

Particularly, rigidity of the vehicle is strengthened and sound blocking and absorbing material is used in hardware aspect, and fuel injection factors such as injection pressure, injection timing, and fuel amount are determined according to engine speed and load, the fuel injection factors are corrected according to environmental variables (e.g., outer temperature, atmospheric pressure, and coolant temperature), and fuel injection is performed based on the corrected fuel injection factors in software aspect in order to reduce combustion noise of the diesel vehicle.

FIG. 5 is a schematic diagram for explaining a conventional method for controlling fuel injection. For convenience of explaining, fuel injection amount is exemplified as a fuel injection factor in FIG. 5.

As shown in FIG. 5, in a state that a throttle opening is a first throttle opening A1, the fuel injection amount is set to a first fuel injection amount F1. If a driver pushes the accelerator pedal for acceleration, the throttle opening is changed from the first throttle opening A1 to a second throttle opening A2. Then, a control portion (not shown) decides a reference fuel injection amount from a predetermined map based on an engine speed and the throttle opening, and decides actual fuel injection amount (herein, the second fuel injection amount F2) by correcting the reference fuel injection amount with environmental variables. After that, the control portion controls an injector (not shown) to inject the fuel by the actual fuel injection amount F2. Accordingly, if the throttle opening is increased to the second throttle opening A2, the fuel injection amount injected by the injector is quickly increased to the second fuel injection amount F2 according to the conventional method for controlling fuel injection. However, if the fuel injection amount is quickly increased to the second fuel injection amount F2, combustion noise may occur.

Generally, the combustion noise mainly occurs at an initial time of acceleration. At the initial time of acceleration, the fuel injection amount, as shown in FIG. 5, increases quickly but air amount supplied in a cylinder increases gradually. Therefore, combustion delay occurs because of momentary rich air/fuel ratio and fast burn occurs. After that, as shown in FIG. 6, rising rate of the combustion pressure becomes steeper. That is, a crank angle at which the combust pressure is highest is delayed from 8° to 15°. After that, if the air amount supplied in the cylinder increases sufficiently, the crank angle at which the combust pressure is highest is returned to an original value. Since the rising rate of the combustion pressure is high, the combustion noise is loud.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a system and a method for controlling fuel injection having advantages of reducing combustion noise and improving fuel economy by deciding fuel injection factors according to a change amount of a driving condition and injecting a fuel according to the fuel injection factors when acceleration.

A system and a method for controlling fuel injection according to an exemplary embodiment of the present invention inject a fuel to an engine through a main injection and/or a pilot injection.

The system for controlling fuel injection may include: a detecting portion detecting a driving condition of the engine; a control portion calculating a change amount of the driving condition from the driving condition of the engine, and deciding actual fuel injection factors based on the driving condition of the engine and the change amount of the driving condition; a high pressure pump controlling a rail pressure according to the actual fuel injection factors; and an injector injecting the fuel according to the actual fuel injection factors.

The control portion may decide reference fuel injection factors according to the driving condition of the engine, correction coefficients according to a change amount of the driving condition of the engine, and the actual fuel injection factor based on the reference fuel injection factors and the correction coefficients.

The driving condition of the engine may include a throttle opening and an engine speed, and the change amount of the driving condition of the engine comprises at least one of a change amount of the throttle opening, a change amount of a fuel injection, a change amount of the engine speed, and a change amount of a vehicle speed.

The correction coefficients according to the change amount of the driving condition of the engine may be decided only when an acceleration condition is satisfied.

The actual fuel injection factor may be decided by adding the reference fuel injection factors with values obtained by multiplying the correcting values of the fuel injection factors and the correction coefficients respectively.

The fuel injection factors may be at least one of main injection timing, pilot injection timing, pilot injection fuel amount, and rail pressure.

The method for controlling fuel injection may include: detecting a driving condition of the engine; calculating a change amount of the driving condition of the engine; deciding reference fuel injection factors according to the driving condition of the engine; deciding correction coefficients according to the change amount of the driving condition of the engine; deciding actual fuel injection factors based on the reference fuel injection factors and the correction coefficients; and injecting the fuel according to the actual fuel injection factors.

The driving condition of the engine may include a throttle opening and an engine speed, and the change amount of the driving condition of the engine comprises at least one of a change amount of the throttle opening, a change amount of a fuel injection, a change amount of the engine speed, and a change amount of a vehicle speed.

The correction coefficients according to the change amount of the driving condition of the engine may be decided only when an acceleration condition is satisfied.

The actual fuel injection factor may be decided by adding the reference fuel injection factors with values obtained by multiplying the correcting values of the fuel injection factors and the correction coefficients.

The fuel injection factors may be at least one of main injection timing, pilot injection timing, pilot injection fuel amount, and rail pressure.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a block diagram of a system for controlling fuel injection according to an exemplary embodiment of the present invention.

FIG. 2 is a flowchart of a method for controlling fuel injection according to an exemplary embodiment of the present invention.

FIG. 3 is a schematic diagram for explaining a method for controlling fuel injection according to an exemplary embodiment of the present invention.

FIG. 4 is a graph showing combustion pressure to crank angle sequentially in a case that fuel injection is controlled according to an exemplary embodiment of the present invention.

FIG. 5 is a schematic diagram for explaining a conventional method for controlling fuel injection.

FIG. 6 is a graph showing combustion pressure to crank angle sequentially in a case that fuel injection is controlled according to a conventional method for controlling fuel injection.

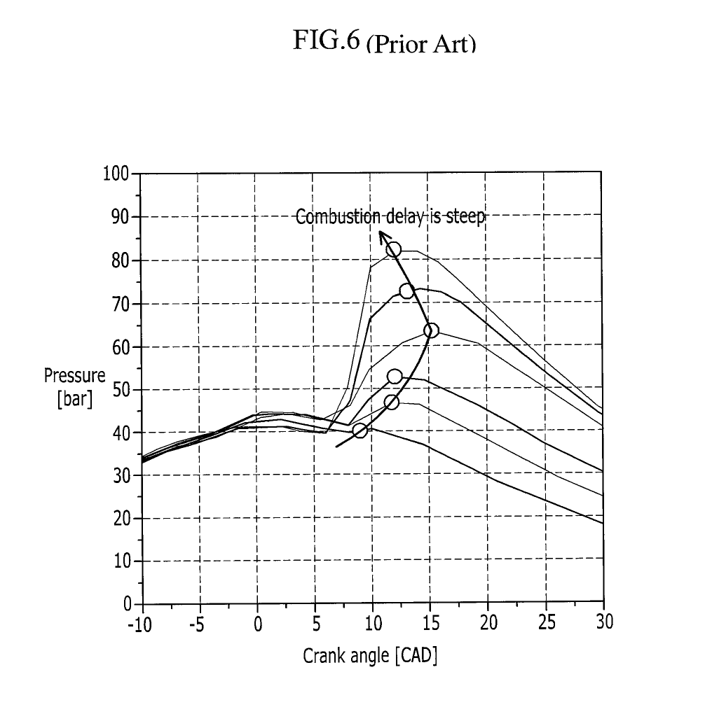

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

An exemplary embodiment of the present invention will hereinafter be described in detail with reference to the accompanying drawings.

A system and a method for controlling fuel injection according to an exemplary embodiment of the present invention control an injection of a fuel to an engine. According to an exemplary embodiment of the present invention, the fuel is supplied to the engine through a main injection and/or a pilot injection. Generally, the number of the main injection is 1, but the number of the pilot injections changes according to a driving condition of an engine and a change amount of the driving condition during a fuel injection cycle. That is, the fuel is supplied to the engine according to the driving condition of the engine and the change amount of the driving condition through only the main injection, the main injection and one pilot injection, the main injection and two pilot injections, or the main injection and at least three times of pilot injections.

In addition, the fuel injection to the engine is controlled by deciding fuel injection factors. Various fuel injection factors may exists, but it is exemplified in an exemplary embodiment of the present invention that the fuel injection factors include main injection timing, pilot injection timing, pilot injection fuel amount, and rail pressure. Herein, the rail pressure represents pressure of a common rail mainly used in diesel engines.

Further, for better comprehension and ease of description, it is exemplified that fuel injection amount is used as the fuel injection factor according to an exemplary embodiment of the present invention. Since main injection fuel amount is generally constant, a change of the fuel injection amount may represent a change of the pilot injection fuel amount. An exemplary embodiment of the present invention described based on the fuel injection amount can be applied to all the fuel injection factors with a little change therein.

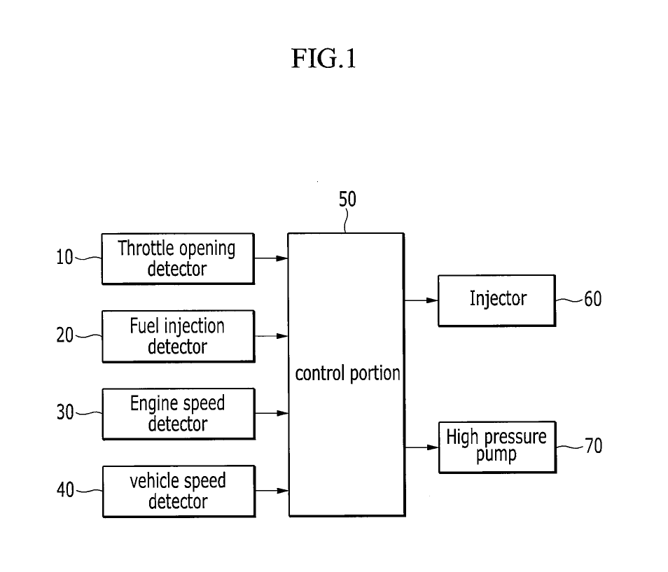

FIG. 1 is a block diagram of a system for controlling fuel injection according to an exemplary embodiment of the present invention.

As shown in FIG. 1, a system for controlling fuel injection according to an exemplary embodiment of the present invention includes a throttle opening detector 10, a fuel injection detector 20, an engine speed detector 30, a vehicle speed detector 40, a control portion 50, an injector 60, and a high pressure pump 70.

The throttle opening detector 10 detects an opening of a throttle valve operated according to an operation of an accelerator pedal, and transmits a signal corresponding thereto to the control portion 50. Instead of the throttle opening detector 10, an accelerator pedal position detector may be used.

The fuel injection detector 20 detects a fuel amount injected by the injector 60, and transmits a signal corresponding thereto to the control portion 50. Since the fuel amount injected by the injector 60 is determined from a predetermined map according to the driving condition of the engine, the control portion 50 may directly calculate the fuel amount injected to the engine instead of using the fuel injection detector 20.

The engine speed detector 30 detects a rotation speed of the engine from a phase change of a crankshaft, and transmits a signal corresponding thereto to the control portion 50.

The vehicle speed detector 40 is mounted at a wheel of a vehicle. The vehicle speed detector 40 detects a rotation speed of the wheel, calculates a vehicle speed from the rotation speed of the wheel, and transmits a signal corresponding thereto to the control portion 50.

The control portion 50 receives the signals corresponding to the driving condition of the engine such as the throttle opening, the fuel injection amount, the engine speed, and the vehicle speed, and decides reference fuel injection factors according to the driving condition of the engine. The reference fuel injection factors according to the throttle opening and the engine speed is predetermined in a map according to an exemplary embodiment of the present invention. Therefore, if the control portion 50 receives the signals corresponding to the throttle opening and the engine speed, the control portion 50 decides the reference fuel injection factors from the predetermined map.

In addition, the control portion 50 calculates the change amount of the driving condition, and decides correction coefficients according to the change amount of the driving condition of the engine and actual fuel injection factors. For this purpose, the control portion 50 includes a correction amount map in which correction amounts according to the driving condition of the engine is predetermined and a correction coefficient map in which the correction coefficients according to the change amount of the driving condition of the engine is predetermined.

The injector 60 injects the fuel to the engine according to the actual fuel injection factors decided by the control portion 50. As described above, the fuel injection factors may include main injection timing, pilot injection timing, pilot injection fuel amount, and rail pressure, and the injector 60 is controlled by the main injection timing, the pilot injection timing, and the pilot injection fuel amount.

The high pressure pump 70 is mounted at a fuel supply circuit and pressurizes the fuel supplied to a common rail. Therefore, the high pressure pump 70 is controlled by the rail pressure among the fuel injection factors.

Meanwhile, structures of the injector 60 and the high pressure pump 70 are well known to a person of an ordinary skill in the art, and thus, detailed description thereof will be omitted.

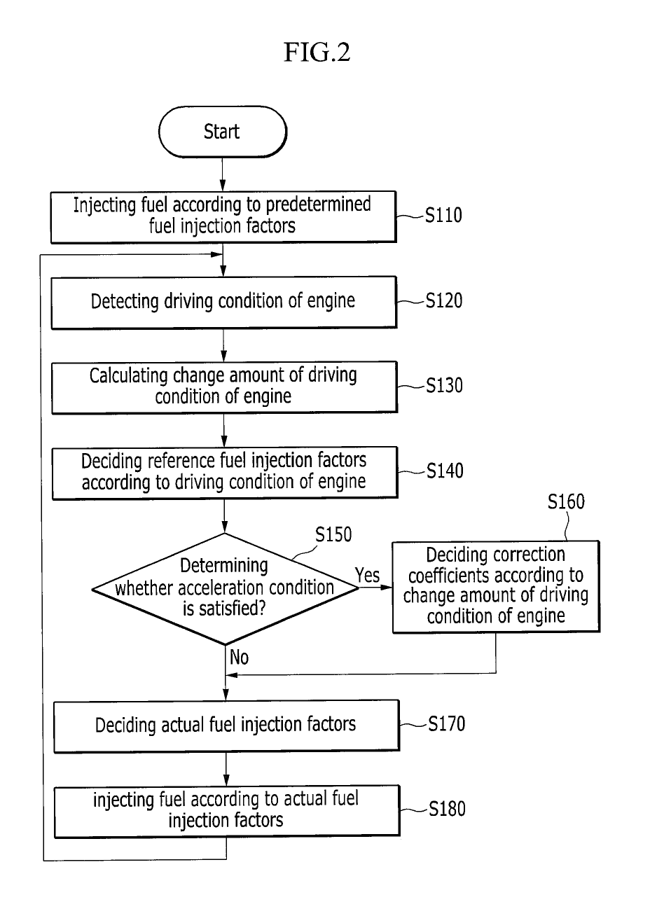

FIG. 2 is a flowchart of a method for controlling fuel injection according to an exemplary embodiment of the present invention.

As shown in FIG. 2, if the engine is started, the control portion 50 controls the injector 60 and the high pressure pump 70 at a step S110 such that the fuel is injected according to predetermined initial fuel injection factors.

In a state that the fuel is injected according to the predetermined initial fuel injection factors, the detecting portion 10, 20, 30, and 40 detects the driving condition of the engine so as to understand a driver's intention at a step S120, and the control portion 50 calculates the change amount of the driving condition of the engine from the detected driving condition of the engine at a step S130. The change amount of the driving condition of the engine is calculated by subtracting a previous driving condition of the engine from a current driving condition of the engine and dividing a difference of the driving condition by an elapsed time.

After that, the control portion 50 decides the reference fuel injection factors according to the driving condition of the engine at a step S140. Since the reference fuel injection factors according to the throttle opening and the engine speed is predetermined in a map, the detecting portion 10, 20, 30, and 40 transmits the signals corresponding to the throttle opening and the engine speed to the control portion 50, and the control portion 50 decides the reference fuel injection factors such as reference main injection timing, reference pilot injection timing, reference pilot injection fuel amount, and reference rail pressure from the predetermined map.

If the reference fuel injection factors are decided, the control portion 50 determines whether an acceleration condition is satisfied at a step S150. The acceleration condition may be satisfied when the throttle opening increases.

If the acceleration condition is not satisfied at a step S150, the control portion 50 decides the reference fuel injection factors as the actual fuel injection factors at a step S170, and injects the fuel according to the actual fuel injection factors at a step S180.

If the acceleration condition is satisfied at the step S150, the control portion 50 decides the correction coefficients according to the change amount of the driving condition of the engine at a step S160. If the driving condition of the engine (i.e., throttle opening and engine speed) at the initial time of the acceleration is the same as that at the end of the acceleration, the same fuel is injected according to a conventional method for controlling fuel injection. Since much power is required at the initial time of the acceleration, the fuel is required much. However, since less power is required at the end of the acceleration, the fuel is required little. Considering this point, an exemplary embodiment of the present invention improves a conventional method for controlling fuel injection in which the fuel injection factors are constant according to the driving condition of the engine and corrects the fuel injection factors according to the change amount of the driving condition of the engine. [Table 1] to [Table 4] show examples of the maps in which the correction coefficients according to the change amount of the driving condition of the engine is set.

TABLE 1
correction coefficient according to change
amount of throttle opening

| | | | | | | | | | |
|---|---|---|---|---|---|---|---|---|---|
| Change | −30 | −20 | −10 | 0 | 2.5 | 5 | 10 | 20 | over |
| amount of | | | | | | | | | 30 |
| throttle opening | | | | | | | | | |
| Correction | 0 | 0 | 0 | 0 | 0 | 0.5 | 0.7 | 0.8 | 1 |
| coefficient K1 | | | | | | | | | |

TABLE 2
correction coefficient according to change amount of fuel

| | | | | | | | | | |
|---|---|---|---|---|---|---|---|---|---|
| Change amount | −10 | −5 | 0 | 2.5 | 5 | 7.5 | 10 | 15 | over |
| of fuel | | | | | | | | | 20 |
| Correction | 0 | 0 | 0 | 0 | 0 | 0.5 | 0.6 | 0.7 | 1 |
| coefficient K2 | | | | | | | | | |

TABLE 3
correction coefficient according to change amount of engine speed

| | | | | | | | | | |
|---|---|---|---|---|---|---|---|---|---|
| Change amount | −150 | −75 | 0 | 37.5 | 75 | 112.5 | 150 | 225 | over |
| of engine speed | | | | | | | | | 300 |
| Correction | 0 | 0 | 0 | 0 | 0 | 0.5 | 0.6 | 0.7 | 1 |
| coefficient K3 | | | | | | | | | |

TABLE 4
correction coefficient according to change amountof vehicle speed

| | | | | | | | | | |
|---|---|---|---|---|---|---|---|---|---|
| Change amount | −10 | −5 | 0 | 1.25 | 2.5 | 3.75 | 5 | 7.5 | over |
| of vehicle speed | | | | | | | | | 10 |
| Correction | 0 | 0 | 0 | 0 | 0 | 0.5 | 0.6 | 0.7 | 1 |
| coefficient K4 | | | | | | | | | |

It is exemplified herein that the change amount of the throttle opening, the change amount of the fuel, the change amount of the engine speed, and the change amount of the vehicle speed are used as the change amount of the driving condition of the engine, but the scope of the present invention is not limited to this. In addition, the control portion 50 may decide all or some of the correction coefficient K1 according to the change amount of the throttle opening, the correction coefficient K2 according to the change amount of the fuel, the correction coefficient K3 according to the change amount of the engine speed, and the correction coefficient K4 according to the change mount of the vehicle speed.

After that, the control portion 50 decides the actual fuel injection factors based on the reference fuel injection factors and the correction coefficients K1, K2, K3, and K4 at a step S170.

If the reference fuel injection factor is X1, and the correcting values of the fuel injection factors are F1, F2, F3, and F4, the actual fuel injection factor X2 is calculated as follows.

X2=X1+K1*F1+K2*F2+K3*F3+K4*F4

Herein, the correcting values of the fuel injection factors F1, F2, F3, and F4 according to the driving condition of the engine are stored in a predetermined map.

In addition, correction of the fuel injection factor may be performed within a predetermined range. For example, the correction amount of the pilot fuel injection is 0-5 mg/st/sec, the correction amount of the pilot injection timing is −500-500 us, the correction amount of the main injection timing is −5-5°, and the correction amount of the rail pressure is −500000 hpa-500000 hpa.

Finally, the control portion 50 injects the fuel to the engine according to the actual fuel injection factors.

Meanwhile, the steps S110 to S180 are repeated while the engine runs.

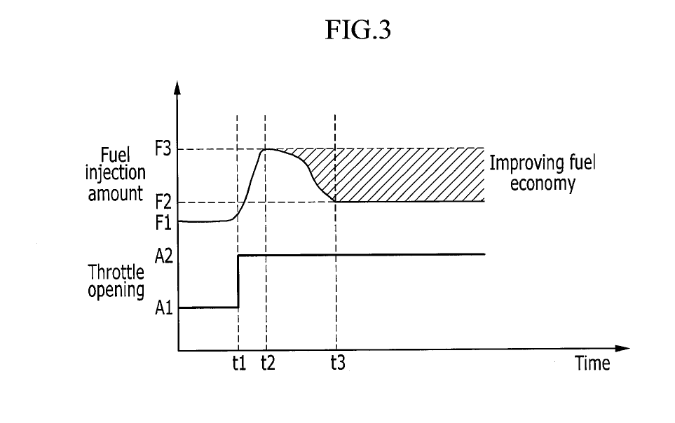

FIG. 3 is a schematic diagram for explaining a method for controlling fuel injection according to an exemplary embodiment of the present invention. For convenience of explanation, the fuel injection amount is exemplified as the fuel injection factor in FIG. 3.

As shown in FIG. 3, in a state that the throttle opening is the first throttle opening A1, the fuel injection amount is set to the first fuel injection amount F1. If the driver pushes the accelerator pedal for acceleration, the throttle opening is changed from the first throttle opening A1 to the second throttle opening A2. At this time, the control portion 50 decides the reference fuel injection amount according to the driving condition of the engine, the correction coefficients according to the change amount of the driving condition of the engine, and the actual fuel injection amount based on the reference fuel injection amount, the correction coefficients and the correction amount of the fuel injection.

In FIG. 3, the change amount of the driving condition of the engine is large from the first time t1 to the second time t2 because of the acceleration. Therefore, the fuel injection amount is increased to the second fuel injection amount F2 from the first time t1 to the second time t2. After that, the fuel injection amount is decreased to the third fuel injection amount F3 from the second time t2 to the third time t3 when the change amount of the driving condition of the engine decreases. Since the change amount of the driving condition of the engine is 0 after the third time t3, the reference fuel injection amount (the same as the third fuel injection amount F3) is injected.

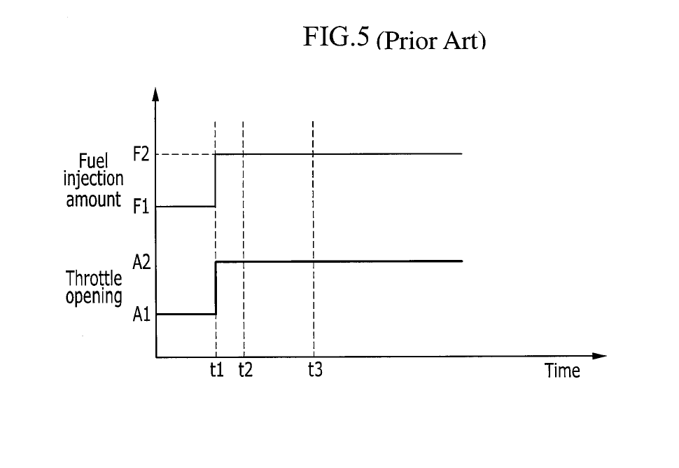

According to the conventional arts (referring to FIG. 5), if the driver pushes the accelerator pedal, the fuel injection amount is quickly increased to the second fuel injection amount F2 and is maintained at the second fuel injection amount F2. However, if the driver pushes the accelerator pedal, the fuel injection amount is gradually increased to the second fuel injection amount F2 at the initial time of the acceleration, but the change amount of the driving condition is decreased and the fuel injection amount is decreased to the third fuel injection amount F3 at the end of the acceleration according to an exemplary embodiment of the present invention. Therefore, fuel economy may improve.

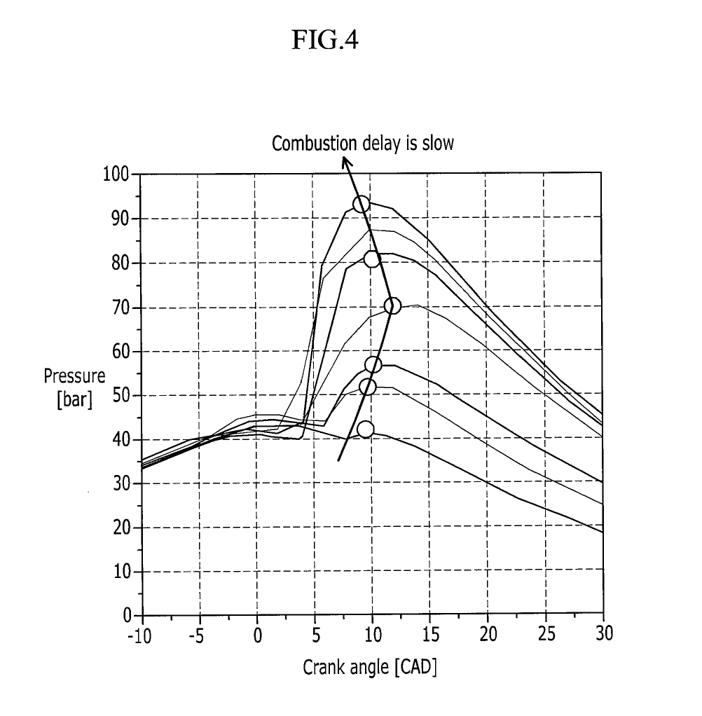

As shown in FIG. 4, the rising rate of the combustion pressure becomes slow according to an exemplary embodiment of the present invention. Accordingly, the combustion noise may be greatly reduced.

As described above, since fuel injection factors is decided according to the change amount of the driving condition and the fuel is injected according to the fuel injection factors when acceleration, combustion noise may be reduced according to an exemplary embodiment of the present invention.

In addition, since the fuel is injected according to the optimized fuel injection factors, fuel economy may improve.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A system for controlling fuel injection which injects a fuel to an engine through main injection and/or pilot injection, comprising:
a detecting portion detecting a driving condition of the engine;
a control portion calculating a change amount of the driving condition from the driving condition of the engine, and deciding actual fuel injection factors based on the driving condition of the engine and the change amount of the driving condition;
a high pressure pump controlling a rail pressure according to the actual fuel injection factors; and
an injector injecting the fuel according to the actual fuel injection factors.

2. The system of claim 1, wherein the control portion decides reference fuel injection factors according to the driving condition of the engine, correction coefficients according to the change amount of the driving condition of the engine, and the actual fuel injection factor based on the reference fuel injection factors and the correction coefficients.

3. The system of claim 2, wherein the driving condition of the engine comprises a throttle opening and an engine speed, and the change amount of the driving condition of the engine comprises at least one of a change amount of the throttle opening, a change amount of a fuel injection, a change amount of the engine speed, and a change amount of a vehicle speed.

4. The system of claim 2, wherein the correction coefficients according to the change amount of the driving condition of the engine is decided only when an acceleration condition is satisfied.

5. The system of claim 2, wherein the actual fuel injection factor is decided by adding the reference fuel injection factors with values obtained by multiplying the correcting values of the fuel injection factors and the correction coefficients respectively.

6. The system of claim 1, wherein the fuel injection factors are at least one of main injection timing, pilot injection timing, pilot injection fuel amount, and rail pressure.

7. A method for controlling fuel injection which injects a fuel to an engine through main injection and/or pilot injection, comprising:
detecting a driving condition of the engine;
calculating a change amount of the driving condition of the engine;
deciding reference fuel injection factors according to the driving condition of the engine;
deciding correction coefficients according to the change amount of the driving condition of the engine;
deciding actual fuel injection factors based on the reference fuel injection factors and the correction coefficients; and
injecting the fuel according to the actual fuel injection factors.

8. The method of claim 7, wherein the driving condition of the engine comprises a throttle opening and an engine speed, and the change amount of the driving condition of the engine comprises at least one of a change amount of the throttle opening, a change amount of a fuel injection, a change amount of the engine speed, and a change amount of a vehicle speed.

9. The method of claim 7, wherein the correction coefficients according to the change amount of the driving condition of the engine is decided only when an acceleration condition is satisfied.

10. The method of claim 7, wherein the actual fuel injection factor is decided by adding the reference fuel injection factors with values obtained by multiplying the correcting values of the fuel injection factors and the correction coefficients respectively.

11. The method of claim 7, wherein the fuel injection factors are at least one of main injection timing, pilot injection timing, pilot injection fuel amount, and rail pressure.
